(19) United States
(12) Patent Application Publication
(10) Pub. No.: US 2013/0117857 A1
(43) Pub. Date: May 9, 2013

(54) Method for Processing Data in One or More Control Devices of a Vehicle, in Particular a Motor Vehicle

(71) Applicant: Bayerische Motoren Werke Aktiengesellschaft, Muenchen (DE)

(72) Inventor: Sebastian Zimmermann, Muenchen (DE)

(21) Appl. No.: 13/728,546

(22) Filed: Dec. 27, 2012

Related U.S. Application Data
(63) Continuation of application No. PCT/EP2011/059478, filed on Jun. 8, 2011.

(30) Foreign Application Priority Data
Jul. 1, 2010 (DE) 10 2010 030 794.7

(51) Int. Cl. G06F 21/62

(52) U.S. Cl. CPC G06F 21/62
USPC 726/27

(57) ABSTRACT

The invention relates to a method for processing data in one or more control devices of a vehicle, in particular a motor vehicle. According to the invention, a data protection mode for the control device(s) can be activated by a user of the vehicle. In this data protection mode the predetermined data, to which the control device(s) has and/or have access during usage of the vehicle, are prevented from being transmitted out of the vehicle; or transmission of said predetermined data is permitted exclusively after entry of a confirmation requested by the user of the vehicle. As an alternative or in addition, in the data protection mode the predetermined data, which are stored in the control device(s) during usage of the vehicle, are deleted after a predefined period of time.

### CROSS-REFERENCE TO RELATED APPLICATIONS

This application is a continuation of PCT International Application No. PCT/EP2011/059478, filed Jun. 8, 2011, which claims priority under 35 U.S.C. §119 from German Patent Application No. 10 2010 030 794.7, filed Jul. 1, 2010, the entire disclosures of which are herein expressly incorporated by reference.

### BACKGROUND AND SUMMARY OF THE INVENTION

The invention relates to a method for processing data in one or more control devices of a vehicle, in particular a motor vehicle, as well as to a corresponding vehicle.

In the modern vehicles of the present time a multitude of data is acquired and stored in corresponding control devices of the vehicle. In this respect it is known from the prior art that these data items are transmitted, as required, outwards to third parties by means of a communication device, in particular over a mobile communication interface of the vehicle, for example, to a so-called backend system, which processes these data items for diagnostic purposes and service purposes and/or for collecting traffic information.

The document DE 102 15 887 A1 describes a method for recording the route history of a route travelled by a motor vehicle. At the same time data regarding the driving conditions are stored during the trip; and these data items are used to derive the traffic information; and additionally the vehicle positions are recorded during the trip. At the end of the trip these data items are transmitted to a central control unit, which further processes these data items in order to make, for example, a traffic jam prognosis for the future.

Within the framework of acquiring and storing data in a vehicle and transmitting said data to external parties, there is the problem that the data may contain sensitive personal or pseudonymous data, which allow conclusions to be drawn about the user of the vehicle and/or his behavior. Consequently there is a need for a vehicle user to be able to play an influential role with respect to the data items that are stored in the vehicle and/or transmitted to a third party, in order to be able to thwart the misuse of said data by unauthorized third parties.

Therefore, the object of the present invention is to provide a method for processing data in one or more control devices of a vehicle. With such a method a user can play an influential role with respect to the processing of data and, in particular, can control the dissemination and/or storage of sensitive data.

This engineering object is achieved by means of a method according to patent claim 1 and/or by means of the vehicle according to patent claim 14. Further developments of the invention are defined in the dependent claims.

The method according to the invention is used for processing data in one or more control devices of a vehicle, in particular a motor vehicle, such as a passenger vehicle. According to this method, a data protection mode for the control device(s) can be activated by a user of the vehicle. That is, a user has the possibility of activating this data protection mode in the vehicle by means of the user's own user interface or more specifically a man to machine interface. This user interface is preferably an interface in the vehicle, in particular, in the form of a control unit with a suitable display. However, if desired, there is also the possibility that the user interface is an interface outside the vehicle, for example, a display on a computer or more specifically a terminal device, which can communicate with the vehicle. This arrangement raises the possibility that a user can activate the data protection mode, even if said user may be located at a distance from the vehicle. In the following the term user interface includes both a user interface in the vehicle and in addition or optionally a user interface that is arranged at a distance from the vehicle.

Based on the method according to the invention, within the framework of the data protection mode the predetermined data, to which the control device(s) has and/or have access during usage of the vehicle by the vehicle user, are prevented from being transmitted out of the vehicle, or transmission of said predetermined data is permitted exclusively after entry of a confirmation requested by the user of the vehicle. This confirmation in turn can be requested by the vehicle user over a suitable user interface. Then the user of the vehicle can enter or refuse the confirmation over this user interface. As an alternative or in addition, the data protection mode can also be configured in such a way that said predetermined data, which are stored in the control device(s) during usage of the vehicle, are deleted after a predefined period of time. The term user of the vehicle is construed in a broad sense within the scope of the invention. It can concern, for example, the driver of the vehicle, but also any other person, who has access to the vehicle or more specifically access to the control devices of the vehicle, based on a corresponding authorization.

The user of the vehicle can be, for example, an employee of a rental car company who can activate the data protection mode, in order to prevent the persistent storage of data of the vehicle lessee in the vehicle. In this case the data protection mode can be activated, for example, over an internet-based interface to the vehicle.

The method according to the invention is characterized by the fact that a vehicle user is offered the possibility of permitting the transmission of data to external parties only under certain conditions and/or preventing a persistent storage of data locally in the vehicle. This feature makes it possible to achieve that certain sensitive data cannot reach an unauthorized third party against the will of the user, with the result that misuse of such data can be prevented.

In a particularly preferred embodiment the predetermined data include personal and/or pseudonymous data of the user of the vehicle. In this case the concept personal and/or pseudonymous data is construed in a broad sense and can include any type of data that can be correlated with the user. In particular, such data are personal data of the user, such as authentication data, personal certificates, passwords and the like, or data that characterize the behavior and/or one or more actions of the user during the usage of the vehicle, in particular the route travelled by the user and/or the vehicle positions along the route travelled and/or the driving style of the user in the form of speed and/or acceleration data and the like. Furthermore, the personal and/or pseudonymous data can include data entered over a user interface and/or include data that can be read out of a terminal device of the user of the vehicle, for example, his mobile telephone and/or also include data received from outside the vehicle. Such data relate, for example, to navigation destinations entered by the user; telephone numbers selected by the user; and/or telephone calls received by the user; messages received or sent by the user (for example SMS or e-mails); or information entered into a screen form during usage of the vehicle, such as logins, passwords and the like.

Furthermore, the personal and/or pseudonymous data can include vehicle settings performed by the user, such as the settings of the outside mirrors, the settings of the seat position, the settings of the steering wheel position and the like. When the data protection mode is activated, in particular a persistent storage of these data items is prevented. That is, the data are deleted again after a predefined period of time, for example, after the end of a trip; and/or the original positions are reset.

In an additional, especially preferred embodiment of the method according to the invention, even after the data protection mode has been activated, the transmission of data out of the vehicle is permitted, nevertheless, under certain conditions. Especially in the case of an accident and/or an emergency situation the vehicle position of the vehicle and/or other vehicle data continue to be transmitted out of the vehicle. In this case these data items reach a third party that can initiate suitable rescue measures. In this case the occurrence of the accident can be detected, for example, by the triggering of airbags; and an emergency situation can exist, for example, if the vehicle user actuates the emergency button that may be found in the vehicle and over which communications with a backend system is opened.

The above-described period of time, after the expiration of which the predetermined data are deleted, is not given by an explicit time interval in one embodiment of the invention, but rather is coupled to an event, in particular to the end of the usage of the vehicle. In this case the usage of a vehicle covers the period of time between the startup of the vehicle (for example, detected by switching on the vehicle ignition) until the vehicle in finally parked (for example, detected by switching off the vehicle ignition). If need be, there is also the possibility that the predefined period of time is changed by the user and is extended over a longer, predefined time interval or shortened to a shorter time interval.

In an additional embodiment of the method according to the invention, an activated data protection mode is automatically deactivated when one or more conditions are met, in particular, at the end of a usage of the vehicle and/or on reaching a route destination, entered into the vehicle, and/or when the vehicle has been parked for a longer period of time than the predefined period of time.

If desired, the vehicle user can specify the end of a data protection mode over a user interface. For example, the user can specify over the user interface that the data protection mode shall be activated at once. As an alternative or in addition, the user can also change, if desired, the future time, at which the data protection mode shall terminate. In particular, at the end of the trip the user can extend the data protection mode to the next usage of the vehicle, if the user has parked his vehicle, for example, only temporarily.

In another especially preferred embodiment of the invention, the vehicle user can be shown an activated data protection mode, in particular in combination with information about the data protection mode, for example, by means of visual or auditory cues, over a user interface. This approach allows the user to be constantly informed about the current operating mode of the control devices.

In an additional embodiment of the method according to the invention the data protection mode comprises a deletion function, which can be activated by the user of the vehicle over a user interface. In this case the user can delete one or more categories of the predetermined data by means of the deletion function. In addition or optionally there is, in particular, the possibility that all of the predetermined data, which are protected within the framework of the data protection mode, are deleted by a single user input. For example, an employee of a rental car company can manually activate the deletion function after the return of a leased vehicle.

In another embodiment of the invention the user can specify over a user interface the predetermined data and, in particular, the categories of predetermined data, for which in the activated data protection mode the transmission out of the vehicle shall be suppressed or for which the transmission shall be permitted only upon confirmation and/or for which the deletion shall be performed after a predefined period of time. As a result, the user can configure the data protection mode in such a way as to meet his own personal requirements.

The predetermined data, which are protected according to the above-described data protection mode, can be data that are processed by arbitrary control devices in the vehicle. In an especially preferred embodiment the predetermined data are data that are processed at least to some extent in one or more control devices of an information or entertainment system in the vehicle. The information and entertainment system, which is also known, in particular, under the term infotainment system, provides functions in the domain of comfort and security of the vehicle and is a unit that has been known from the prior art for some time.

In addition to the above-described method the invention also relates to a vehicle, in particular a motor vehicle, comprising one or more control devices. In this case a data protection mode for the control device(s) can be activated by a user of the vehicle, based on the method according to the invention and, in particular, based on one or more of the above-described variants of the method according to the invention.

Other objects, advantages and novel features of the present invention will become apparent from the following detailed description of one or more preferred embodiments when considered in conjunction with the accompanying drawings.

### BRIEF DESCRIPTION OF THE DRAWINGS

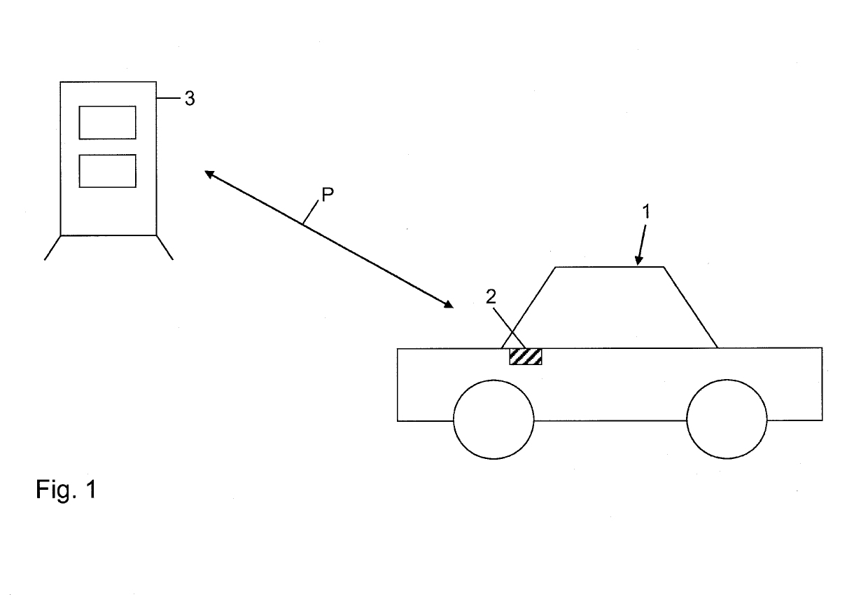

One embodiment of the invention is described in detail below with reference to the attached FIG. 1.

### DETAILED DESCRIPTION OF THE DRAWINGS

According to FIG. 1, the use of a data protection mode for a control device 2 in a vehicle infotainment system of a vehicle 1 is described. In this case the infotainment system comprises, among other things, the functionalities of the GPS-based navigation of the vehicle, the communication of the vehicle with the driver and to the outside, and the display of the multimedia contents. In this context the control device is preferably the so-called main unit (English: head unit) of the infotainment system. In the normal operating mode the vehicle can communicate with a backend system composed of a plurality of servers over a suitable wireless interface (for example, a mobile communication interface). One server of this backend system is indicated with the reference numeral 3; and the communication between the vehicle 1 and the backend server 3 is shown by the double arrow P. The backend system, which is usually operated by the vehicle manufacturer, can perform a variety of functionalities. For example, the current position of the vehicle and/or the current information about the traffic situation and/or the route calculation data of the navigation system of the vehicle can be transmitted to said backend system. These data items can be used to provide value added services. For example, the user can be provided with information about the route travelled by said user, in particular, information about traffic jams. Then the user of the vehicle can have this information displayed on a suitable man to machine interface.

Within the framework of the communication of the vehicle with a backend system there is the problem that the exchanged data are often user specific data which raises the possibility that conclusions can be drawn about the person of the user and/or the user's behavior and/or the user's habits. Although these data items are anonymized in order to protect against misuse, a vehicle user does not have the possibility of preventing the transmission of such data and their further processing in a backend system. At this point the invention described below provides a vehicle user with the possibility of controlling the transmission of data between the vehicle 1 and the backend system 3. This feature can be achieved by implementing a data protection mode in the control device 2; and this data protection mode can be activated by the vehicle user over a suitable user interface in the vehicle. In addition or optionally, there is also the possibility that a user activates or deactivates from a distance such a data protection mode by means of his terminal device, for example, his mobile telephone, based on a communication between the mobile telephone and the vehicle. In order to enable such a data protection mode, the software of the control device 2 is suitably modified, in order to suppress transmissions out of the vehicle to the backend system and/or to permit said transmission only under predefined conditions.

The data, which are protected within the scope of the data protection mode and for which the transmission out of the vehicle is suppressed or for which the transmission is possible only to a limited extent, can be any information that relates to the user in any way. Such data are, in particular, information that specifies the user and/or the characteristics of the user and/or the behavior and/or actions of the user. Examples of user related data are the route travelled by the user and/or the current position of the vehicle and/or the personal certificates of the user, such as an authentication of the user for e-mail retrieval, setting up a VPN channel and the like.

The data protection mode in the vehicle can be configured in a variety of ways. For example, there is the possibility that any and all transmissions of personal and/or pseudonymous data out of the vehicle are suppressed; and/or that a transmission out of the vehicle is permitted for certain personal and/or pseudonymous data; and/or that for other personal and/or pseudonymous data the transmission to the outside is not permitted. Similarly there is the possibility that a transmission of any type of personal and/or pseudonymous data and/or certain personal and/or pseudonymous data is suppressed when a confirmation, requested by the control device, is entered by the vehicle user into a suitable user interface in the vehicle. That is, only after an explicit confirmation of a planned transmission of information out of the vehicle is this transmission actually executed.

In one variant of the method according to the invention, such data are removed from the data protection mode that are transmitted to the backend system in the event of an accident and/or an emergency situation. Such data include, in particular, the GPS-determined position of the vehicle, so that the backend system can send rescue services to the location of the vehicle. An accident can be detected, for example, based on the detection of the triggering of airbags or other safety systems in the vehicle. Similarly there is the possibility that an emergency situation is initiated in that the vehicle user actuates the emergency button in the vehicle, with the result that a communication link to the backend system is set up, in particular, by means of a mobile communication device. At the same time the position of the vehicle is also transmitted within the framework of the communication.

The above-described data protection mode can be expanded in a suitable way to include the local storage of user-related data in the control device of the vehicle. In accordance with such an expansion, the predetermined data relating to the user are not persistently stored in the vehicle, but rather are deleted again after a predefined period of time, in particular, after a so-called life cycle of the vehicle. In this context the life cycle specifies a usage interval of the vehicle, which commences, in particular, starting from the time that the ignition of the vehicle is switched on and continues to run until the vehicle is parked. This expansion feature ensures that data, which are acquired in the vehicle and/or entered over a corresponding user interface, are no longer available in the next life cycle, so that in the case that a different user of the vehicle is driving in the next life cycle, this different user does not have access to the information relating to the previous user. This variant of the invention can be used within the framework of a distributed usage of a vehicle, for example, when the vehicle is used by a rental car company, because in this case the vehicle will be driven by a number of different users. The data, which are deleted from the vehicle at the end of a life cycle, can be, for example, once again any data that relate to the user, for example, telephone numbers, which the user selected while he was using the vehicle; calls received by the user; vehicle settings performed by the user, such as setting of the air conditioning system, the outside mirror, the seat position, the steering wheel position and the like. The data can also include the login, entered by the user over a user interface of the vehicle, or search screens, filled out by the user over a user interface of the vehicle, in particular search screens of a web browser, which was used during usage of the vehicle. Similarly the data can concern messages, which were sent out of the vehicle by the user or received by the user in the vehicle, such as e-mails, SMS messages and the like. Furthermore, such data could also include radio stations stored on station keys, other settings of freely programmable keys, bookmarks or other MMI settings. All of these information items, which are stored temporarily during the trip, are then deleted permanently after the end of the trip.

In an additional embodiment of the invention there is the possibility that the data protection mode is automatically terminated after the end of a trip and/or a life cycle and has to be explicitly re-activated by the user at the start of the next life cycle. If desired, the vehicle user can specify at the end of a life cycle that the data protection mode shall be extended to the next life cycle, for example, when the vehicle user interrupts his trip only temporarily. Similarly it is possible that the vehicle user defers the deletion of personal and/or pseudonymous data, which are stored locally in the vehicle and deleted after a life cycle, until the next life cycle, so that the user continues to have access to the personal data, which he has already entered, for a longer period of time and does not have to enter said personal data again.

In accordance with the invention the termination of the data protection mode can be linked not only to the end of a life cycle, but also to any other condition. For example, the data protection mode does not have to be deactivated until after a prolonged immobilization period of the vehicle and/or not until one of the route destinations specified by the driver of the vehicle has been reached. In an additional embodiment of the data mode according to the invention, the activation of the data protection mode is displayed in a suitable way on a man to machine interface in the vehicle, in particular, on a display by means of an informative icon. If desired, additional information about the data protection mode can be depicted on the man to machine interface, for example, information regarding which data shall not be transmitted to the outside within the framework of the data protection mode and/or shall be deleted again after the end of the trip.

If desired, the above-described data protection mode can be expanded to include a deletion function, so that all personal and/or pseudonymous data can be deleted following activation of the deletion function. In this respect the deletion function can be activated by the vehicle user over a corresponding man to machine interface. For example, all of the navigation destinations, specified by the user during the trip, the user's call lists; his music library; the messages that the user sent out and/or received; his logins; his personal certificates as well as any other personal and/or pseudonymous data can be deleted at once.

The above-described method according to the invention has a number of advantages. In particular, the use of personal and/or pseudonymous data of a vehicle user by unauthorized third parties can be suppressed by activating a data protection mode. In this respect the data protection mode can be configured in a variety of ways as a function of the application. In particular, the transmission of personal and/or pseudonymous data out of the vehicle can be suppressed in general and/or can be permitted by the user only after an explicit confirmation. The data protection mode can also be expanded to include the storage of personal and/or pseudonymous data in the vehicle. In this case upon activation of the data protection mode the data are not stored persistently in the vehicle, but rather are deleted again after a predefined period of time, in particular after the end of a life cycle of the vehicle. If desired, the data protection mode can also be configured in such a way that it prevents only the persistent storage of personal and/or pseudonymous data and does not concern itself with suppressing the transmission of data out of the vehicle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for processing data in one or more control devices of a vehicle, wherein a data protection mode for the one or more control devices can be activated by a user of the vehicle and, when in the data protection mode, predetermined data to which the one or more control devices have access during usage of the vehicle are at least one of:
prevented from being transmitted out of the vehicle,
permitted to be transmitted only after entry of a confirmation requested by the user of the vehicle, and
deleted, after a predefined period of time, from the one or more control device in which such predetermined data are stored during usage of the vehicle.

2. The method of claim 1, wherein the predetermined data include personal or pseudonymous data of the user of the vehicle that characterizes at least one of behavior and one or more actions of the user during usage of the vehicle.

3. The method of claim 2, wherein the personal or pseudonymous data include at least one of vehicle positions recorded during the trip of the vehicle, and information items which specify the route travelled by the user of the vehicle.

4. The method of claim 2, wherein the personal or pseudonymous data include at least one of data entered over a user interface, data that can be read out of a terminal device of the user of the vehicle, and data received from outside the vehicle.

5. The method of claim 3, wherein the personal or pseudonymous data include at least one of data entered over a user interface, data that can be read out of a terminal device of the user of the vehicle, and data received from outside the vehicle.

6. The method of claim 2, wherein the personal or pseudonymous data include vehicle settings performed by the user of the vehicle.

7. The method of claim 3, wherein the personal or pseudonymous data include vehicle settings performed by the user of the vehicle.

8. The method of claim 4, wherein the personal or pseudonymous data include vehicle settings performed by the user of the vehicle.

9. The method of claim 1, wherein, when in the data protection mode, in the case of one of an accident of the vehicle or an emergency situation, at least one of a vehicle position and additional vehicle data continue to be transmitted out of the vehicle.

10. The method of claim 1, wherein the predetermined period of time is coupled an end of the usage of the vehicle, and wherein the predefined period of time can be changed by the user of the vehicle.

11. The method of claim 1, wherein an activated data protection mode is automatically deactivated when at least one of the following conditions are met: an end of the usage of the vehicle, reaching a route destination entered into the vehicle, and when the vehicle has been parked for a longer period of time than the predefined period of time.

12. The method of claim 2, wherein an activated data protection mode is automatically deactivated when at least one of the following conditions are met: an end of the usage of the vehicle, reaching a route destination entered into the vehicle, and when the vehicle has been parked for a longer period of time than the predefined period of time.

13. The method of claim 1 wherein the user of the vehicle can specify the end of an activated data protection mode over a user interface.

14. The method of claim 1, wherein the user of the vehicle is shown an activated data protection mode, in combination with information about the data protection mode, over a user interface.

15. The method of claim 1, wherein the data protection mode comprises a deletion function which can be activated by the user of the vehicle over a user interface, and wherein the user can delete one or more categories of the predetermined data using said deletion function.

16. The method of claim 1, wherein the user of the vehicle can specify, over a user interface, the predetermined data, including one or more categories of predetermined data for which, in the activated data protection mode, one or more of transmission out of the vehicle shall be suppressed, transmission shall be permitted only upon confirmation, and deletion shall be performed after a predefined period of time.

17. The method of claim 1, wherein the predetermined data are at least partially processed in one or more control devices of an information or entertainment system in the vehicle.

18. A vehicle comprising one or more control devices, wherein a data protection mode for one or more control devices can be activated by a user of the vehicle and, when in the data protection mode, predetermined data to which the one or more control devices have access during usage of the vehicle are at least one of:
prevented from being transmitted out of the vehicle, permitted to be transmitted only after entry of a confirmation requested by the user of the vehicle, and deleted, after a predefined period of time, from the one or more control device in which such predetermined data are stored during usage of the vehicle

19. The vehicle of claim 18, wherein the predetermined data include personal or pseudonymous data of the user of the vehicle that characterizes at least one of behavior and one or more actions of the user during usage of the vehicle.

20. The vehicle of claim 18, wherein an activated data protection mode is automatically deactivated when at least one of the following conditions are met: an end of the usage of the vehicle, reaching a route destination entered into the vehicle, and when the vehicle has been parked for a longer period of time than the predefined period of time.
